(19) United States
(12) Patent Application Publication
(10) Pub. No.: US 2010/0325426 A1
(43) Pub. Date: Dec. 23, 2010

(54) PROTECTED SOFTWARE IDENTIFIERS FOR IMPROVING SECURITY IN A COMPUTING DEVICE

(75) Inventor: Jonathan Dixon, Surrey (GB)

Correspondence Address: Saul Ewing LLP (Philadelphia);Attn: Patent Docket Clerk, Penn National Insurance Plaza, 2 North Second St., 7th Floor, Harrisburg, PA, 17101, US

(73) Assignee: SYMBIAN SOFTWARE LTD., London (GB)

(21) Appl. No.: 12/063,178

(22) PCT Filed: Aug. 8, 2006
(86) PCT No.: PCT/GB06/02964

§ 371 Date: Sep. 8, 2010

(30) Foreign Application Priority Data
Aug. 10, 2005 (GB) 0516471.0

(51) Int. Cl. H04L 9/32

(52) U.S. Cl. 713/156

(57) ABSTRACT

A computing device is operated in a manner such that, where application software includes a unique software identifier, this can be taken from an unprotected range (which can be allocated to any application software) or from a protected range (which can only be used by digitally signed software). On installation, the unique software identifiers are checked to ensure they do not clash with any belonging to software already on the device, and that, if they are from the protected range, the software being installed was digitally signed. Checks for ownership of the unique identifiers can also made at the time an application is signed.

This invention discloses a means of operating a computing device so as to provide a more secure computing device, and in particular to a means of operating a computing device whereby an improved method of enabling application software to offer proof of its identity at run time.

The term ‘computing device’ includes, without limitation, Desktop and Laptop computers, Personal Digital Assistants (PDAs), Mobile Telephones, Smartphones, Digital Cameras and Digital Music Players. It also includes converged devices incorporating the functionality of one or more of the classes of device already mentioned, together with many other industrial and domestic electronic appliances.

A computing device that allows its owner or user to install software providing new applications or new functionality is termed an open device. Though there are clear benefits to being able to extend the utility of a device in this way, it is apparent that this facility can represent a significant security risk for the owner or user. Where the computing device is connected to other devices over a network, the risk can extend to all other devices connected to the network, and threatens even the integrity of the network itself.

There is now widespread awareness that there is a significant risk of malicious programs (or malware) affecting open computing devices. A recent Internet article (http://en.wikipedia.org/wiki/Malware) identifies and describes eleven different types of malware, which include Viruses, Worms, Wabbits, Trojans, Backdoors, Spyware, Exploits, Rootkits, Key Loggers, Dialers and URL injectors.

Open computing devices are generally provided with an operating system, or OS. As well as managing the system hardware and providing a platform of commonly used facilities enabling the operating of application software which runs above it, a modern operating system also provides facilities for managing the lifecycle of such application software. It loads application software prior to execution, frees resources when an application terminates, and handles both the installation and removal of such software.

The operating system is therefore a natural focus of efforts to protect programmable computing devices from various types of malware. A well-designed operating system with a focus on platform security should
a. take steps to prevent malware being installed on a device; and
b. in the event of malware finding its way on to the device automatically detect the infection; and
   i. take steps to prevent the malware being executed; and in the event of the execution of malware
   ii. take steps to limit the damage that it can do.

There are a number of well-known techniques for providing functionality (a) described above, which aim to identify malware or software infected with malware, and preventing it from being installed on a device. They generally rely on a combination of authentication and certification technologies and provide perimeter security. An application to be installed is normally packaged together with a verifiable signed certificate confirming the good standing of the author and also with one or more hashes or other type of message digest of the contents of the package, which enable any tampering to be detected. Once the origin of an application has been safely confirmed, together with its integrity, it can safely be installed on a computing device with a high degree of assurance.

Techniques for providing functionality (b) above are more varied. They include the use of access control lists, by which users of the device need to have been granted special privileges in order to use software that is able to undertake sensitive operations, and are denied the access rights to such operations if these privileges have not been granted. This approach has certain vulnerabilities in that it monitors only the user of the device and not the software applications they are running.

A rather better approach to providing functionality (b) is the software capability model, as disclosed in patent applications PCT/GB03/02311 entitled “Secure Mobile Wireless Device” and patent application PCT/GB03/02313 entitled “Mobile Wireless Device with Protected File System”. PCT/GB03/02311 describes how all executable software on a computing device must have been granted certain software capabilities in order to undertake sensitive operations. The activities of all such application software is monitored by a Trusted Computing Base (TCB) of core software on the device which can be relied on not to be subverted; the TCB typically includes both the application launcher and the file system.

PCT/GB03/02313 describes how a capability model can be extended to protect the data storage system of a computing device by partitioning it in such a way that prevents any application software from accessing arbitrary private data that does not belong to it by requiring either a proof of identity or special capabilities in order to access such data.

It should be understood that this proof of identity offered by an item of executable software is not the same thing as that proof of identity required by access control mechanisms; it does and cannot take the form of passwords or passphrases or biometric data which are proffered by a user or owner of the device at access time. Instead, this proof of identity takes the form of an identifier which is guaranteed to be globally unique and which has been granted to an item of executable software at build time.

The traditional proofs of identity are either digitally signed certificates or globally unique software identifiers (GUIDs).

Digitally signed certificates are used when installing software, but are computationally very expensive and are far too heavyweight for continuous use in a computing device at run time.

In contrast, GUIDs are quick and simple to check; they are included in the binary executable and can easily be checked at run time with a simple arithmetic comparison. They are already in use in many computing devices. For example, Microsoft use 128 bit GUIDs for several purposes and these indirectly rely on a centralised IEEE Ethernet MAC address allocation database, from which they are formed. Please see http://standards.ieee.org/regauth/oui/index.shtml). The integrity of this solution depends on every user respecting the IEEE GUID allocation algorithm, and it is well known that MAC addresses do not have any defense against impersonation or spoofing attacks. Adding this feature to the scheme would involve pushing the verification problem off on to a secondary centralised database administering additional cryptographic measures.

Symbian OS devices (prior to OS version 9.0) use a cooperative centralised database for issuing their 32 bit UIDs. Palm OS 4 character Creator IDs used the same mechanism. In both these cases, no authentication was applied or enforced; in practice any software could use any identifier, and there was no scope to restrict a GUID to a specific identified executable.

It is clear to those skilled in the art that for GUIDs to be secure, not only is a central identifier allocation authority required, but authentication and verification measures are also essential; these need to be applied to the granting of a GUID, to the applicant, and to each use.

There is no obvious way of avoiding a potentially heavyweight procedure here, even though a lightweight one would be preferable. Furthermore, unsigned software with no capabilities at all should ideally be freely installable on an open platform; there is no obvious way of reconciling this requirement with the need to protect sensitive high-security applications.

According to a first aspect of the present invention there is provided a method of operating a computing device in which
a. all executables in application software that runs on the device have to include an inbuilt proof of their identity that is checked by the device before they are granted access to any stored data or other resources on the device; and
b. the said proof of identity takes the form of globally unique identifiers (GUIDs); and
c. the range of GUIDs known to be valid on the device is divided into a protected and an unprotected range; and
d. all the said application software that was not included on the device at the time of manufacture has to be installed on the device by a single component (the installer) before it is able to run; and
e. the said application software may or may not be signed with a digital certificate that must be validated by the installer prior to its installation; and
f. the installer ensures that the GUIDs of any executables in software to be installed on the device are not the same as the GUIDs of any executables that have previously been installed on the device, either at manufacture time or subsequently; and
g. the installer does not install any application software that contains executables that have GUIDs in the protected range unless it was signed with a valid digital certificate.

According to a second aspect of the present invention there is provided a method of manufacturing software to run on a computing device arranged to operate in accordance with a method of the first aspect, in which applications are not digitally signed if they contain executables with GUIDs that have not been allocated to the owner, manufacturer or author of the software or one of their known authorised agents.

According to a third aspect of the present invention there is provided a computing device arranged to operate in accordance with a method of the first aspect.

According to a fourth aspect of the present invention there is provided an operating system for causing a computing device to operate in accordance with the first aspect or to manufacture software in accordance with the second aspect.

An embodiment of the present invention will now be described, by way of further example only, with reference to the accompanying drawings, in which:—

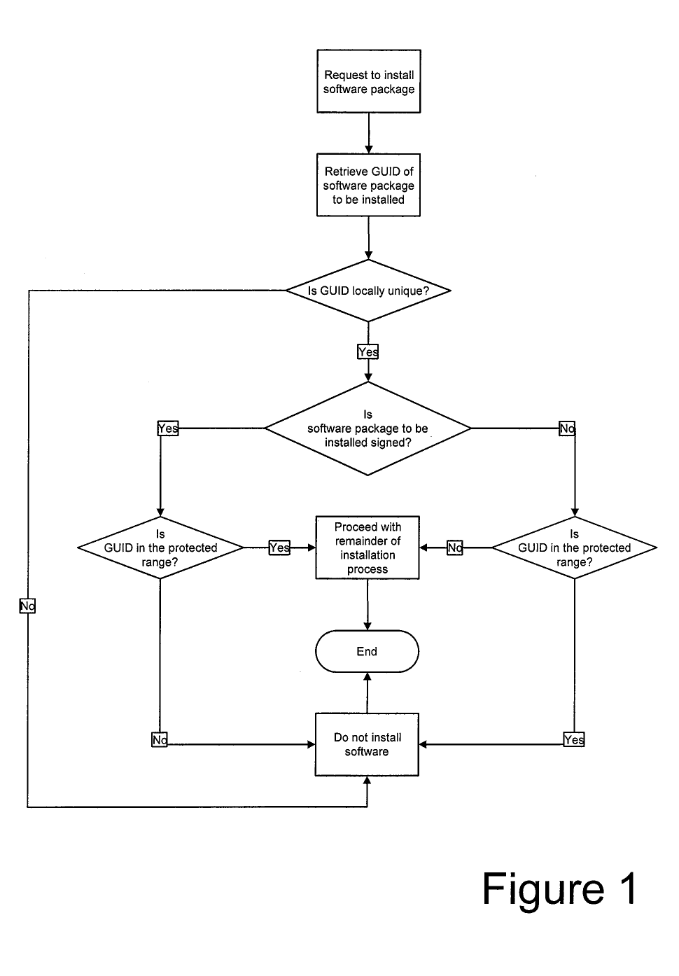

FIG. 1 shows a method of operating a computing device in accordance with the present invention; and

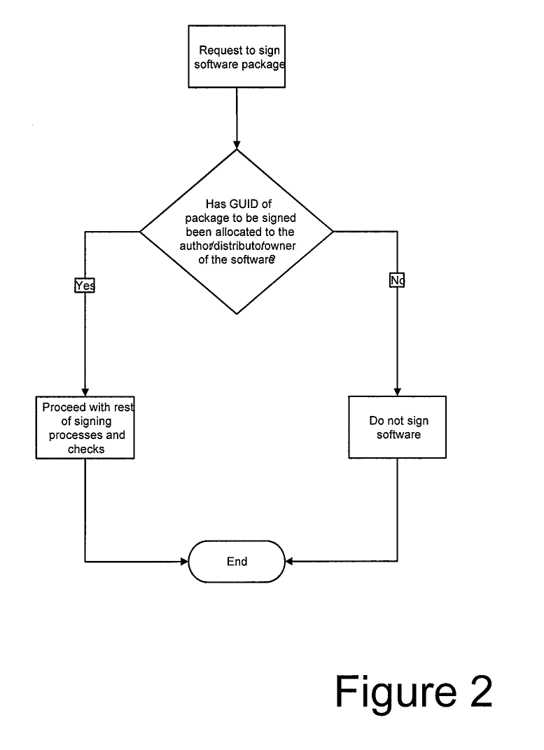

FIG. 2 shows a method of operating a computing device to effect signing of a software package in accordance with an embodiment of the present invention.

In essence, this invention provides a lightweight method of protecting sensitive software whilst enabling the device to be maintained as an open device. It relies on the following insights:
Where a GUID is to be used to protect private data on a device in conjunction with perimeter security, it is only necessary for the perimeter security to check that the executable being installed has an identifier that is locally unique. Attempts to steal data that involve spoofing a globally unique ID that is not being used on the device are attacking data that does not in fact exist.
While some software performs have highly sensitive operations and store highly sensitive data, not all software is of this type. For example, the security measures that protect data belonging to home banking application software are not necessarily applicable for arcade games. Therefore, dividing a range of GUIDs into a section reserved for high security applications and a section reserved for less secure applications allows a less stringent policy to be applied to certain categories of software.

This invention has three related aspects as follows:
1. Whenever executable software is installed on a computing device, a local uniqueness check is made on the GUID. If any other software units are already installed using the GUID, the new install will fail. This procedure is shown in FIG. 1. Assuming that the computing device has adopted the fairly basic perimeter security measure of ensuring that all executable software uses a single mandatory software installer, this measure is by itself sufficient to ensure that all GUIDs are guaranteed to be unique on the device, and therefore guaranteed that no applications already installed are being spoofed and that all private data guarded by existing GUIDs on the device remains private.
2. A subset of the numeric range of the GUIDs (for example, the lower half of the range for 32-bit UIDs) is kept reserved so that only signed applications may use identifiers in this range. In the context of the present invention, this range is referred to as the protected range. The installer within the device will refuse to install software that has a GUID in this range unless it is signed. This procedure can also be seen in FIG. 1.
3. When applications are being signed, authentication checks include ensuring that executables being signed do not use any GUIDs that have not been allocated to an owner of that software. This measure is shown in FIG. 2.

Together, these measures mean:
a. all software has the guarantee of local uniqueness on any single device;
b. signed software has the guarantee of global uniqueness;
c. protected identifiers remain unique within the 32 bit allocation space.

This invention offers clear advantages over previous methods of operating a computing device:
1. It requires no cryptographic mechanisms to check identifiers.
2. It requires no cryptographic mechanisms at installation time for unsigned software.
3. It guarantees that all software has an identifier that is at least locally unique, and that therefore all local private data is protected.
4. It guarantees that unsigned software cannot masquerade as signed software that uses a GUID in the protected range, whether for a denial of service (DOS) attack or any other purpose.
5. In general, runtime checks on GUIDs do not need to consider how they were allocated.

In summary, therefore, where application software includes a unique software identifier, this can be taken from an unprotected range (which can be allocated to any application software) or from a protected range (which can only be used by digitally signed software). On installation, the unique software identifiers are checked to ensure they do not clash with any belonging to software already on the device, and that, if they are from the protected range, the software being installed was digitally signed. Checks for ownership of the unique identifiers are also made at the time an application is signed.

Although the present invention has been described with reference to particular embodiments, it will be appreciated that modifications may be effected whilst remaining within the scope of the present invention as defined by the appended claims.

1. A method of operating a computing device in which
a. all executables in application software that runs on the device have to include an inbuilt proof of their identity that is checked by the device before they are granted access to any stored data or other resources on the device; and
b. the said proof of identity takes the form of globally unique identifiers (GUIDs); and
c. the range of GUIDs known to be valid on the device is divided into a protected and an unprotected range; and
d. all the said application software that was not included on the device at the time of manufacture has to be installed on the device by a single component (the installer) before it is able to run; and
e. the said application software may or may not be signed with a digital certificate that must be validated by the installer prior to its installation; and
f. the installer ensures that the GUIDs of any executables in software to be installed on the device are not the same as the GUIDs of any executables that have previously been installed on the device, either at manufacture time or subsequently; and
g. the installer does not install any application software that contains executables that have GUIDs in the protected range unless it was signed with a valid digital certificate.

2. A method of manufacturing software to run on a computing device arranged to operate in accordance with a method as claimed in claim 1, in which applications are not digitally signed if they contain executables with GUIDs that have not been allocated to the owner, manufacturer or author of the software or one of their known authorised agents.

3. A computing device arranged to operate in accordance with a method as claimed in claim 1.

4. A computing device operable to manufacture software in accordance with a method as claimed in claim 2.

5. An operating system for causing a computing device to operate in accordance with a method as claimed in claim 1.
